(19) United States
(12) Patent Application Publication
(10) Pub. No.: US 2016/0063234 A1
(43) Pub. Date: Mar. 3, 2016

(54) ELECTRONIC DEVICE AND FACIAL RECOGNITION METHOD FOR AUTOMATICALLY LOGGING INTO APPLICATIONS

(71) Applicant: HON HAI PRECISION INDUSTRY CO., LTD., New Taipei (TW)

(72) Inventors: JEN-HSIUNG CHARNG, New Taipei (TW); MING-CHUAN KAO, New Taipei (TW); SHIH-HUNG CHIOU, New Taipei (TW); HSIUNG-YI YANG, New Taipei (TW); CHAO-TING LAI, New Taipei (TW)

(21) Appl. No.: 14/832,358

(22) Filed: Aug. 21, 2015

(30) Foreign Application Priority Data
Aug. 29, 2014 (TW) 103129856

(51) Int. Cl. G06F 21/32; G06K 9/00; H04N 5/232

(52) U.S. Cl. CPC G06F 21/32; H04N 5/23229; G06K 9/00288

(57) ABSTRACT

A method for logging into a number of applications of an electronic device includes obtaining a login facial image of a user when the user opens a first application of the number of applications, determining whether the login facial image matches a preset facial image stored in the electronic device, and logging into the first application when the login facial image matches the preset facial image. The preset facial image is linked to each of the number of applications. The electronic device automatically logs into the rest of the applications when the rest of the applications are opened, after the login facial image matches the preset facial image to log into the first application.

### FIELD

The subject matter herein generally relates to an electronic device and a facial recognition method thereof for automatically logging into a plurality of applications.

### BACKGROUND

Facial recognition technology is becoming more and more advanced and can be implemented in a variety of electronic devices. To log into different applications of an electronic device, such as a smart phone, developed by different providers, a user of the electronic device needs to proceed through respective facial recognitions of the applications, which is quite inconvenient for the user.

### BRIEF DESCRIPTION OF THE DRAWINGS

Implementations of the present technology will now be described, by way of example only, with reference to the attached figures.

FIG. 1 is a block diagram of an embodiment of an electronic device for logging into a plurality of applications, the electronic device including a facial image recognition and login integration system.

FIG. 2 is a block diagram of an embodiment of function modules of the facial image recognition and login integration system of FIG. 1.

FIG. 3 is a flowchart of an embodiment of a method for automatically logging into a plurality of applications.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

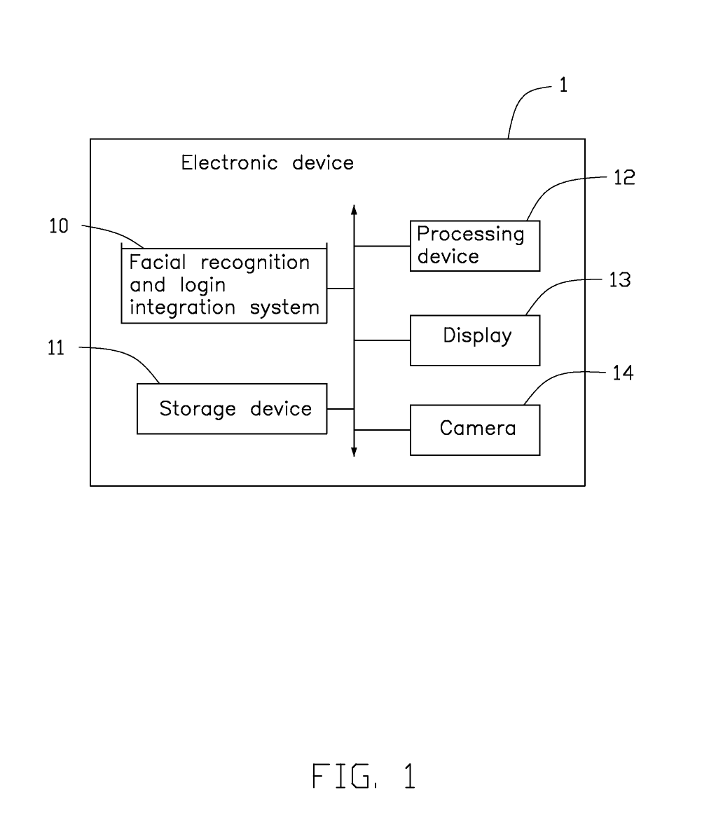

FIG. 1 illustrates an embodiment of an electronic device 1. The electronic device 1 can automatically log into a plurality of applications installed therein. The electronic device 1 can include a facial recognition and login integration system 10 (hereinafter referred to as “the system 10”), a storage device 11, a processing device 12, a display 13, and a camera 14. The system 10 can obtain a login facial image of a user, and determine whether the login facial image matches a preset facial image. The storage device 11 can store the preset facial image and a plurality of linking relationships. The system 10 can automatically log into the plurality of applications according to the linking relationships when the login facial image matches the preset facial image. The display 13 can display the plurality of applications. The camera 14 can capture the login facial image of the user. In at least one embodiment, the electronic device 1 can be a mobile electronic device such as a tablet computer or a smart phone.

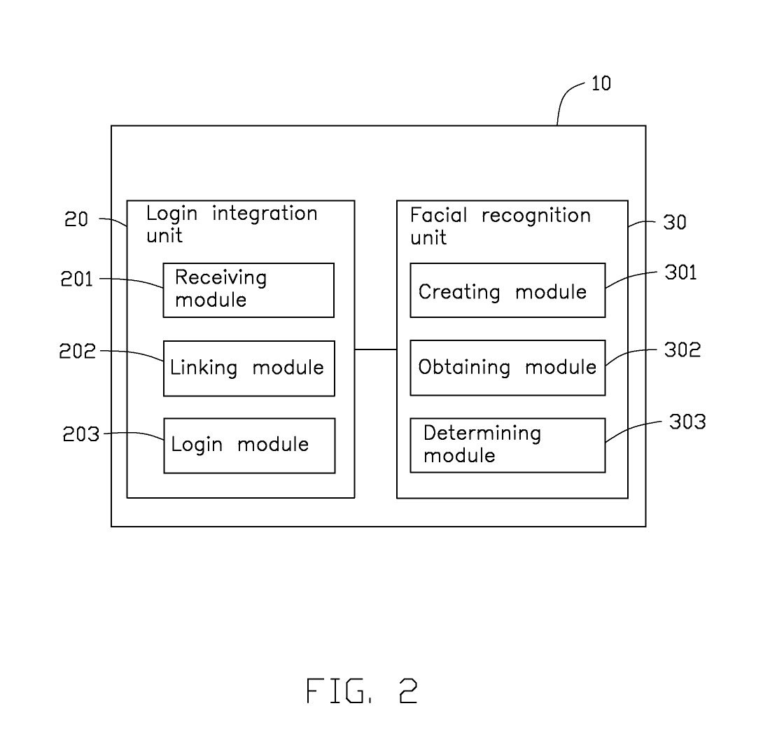

Referring to FIG. 2, the system 10 can include a login integration unit 20 and a facial recognition unit 30. The login integration unit 20 can include a plurality of modules, such as a receiving module 201, a linking module 202, and a login module 203. The facial recognition unit 30 can include a creating module 301, an obtaining module 302, and a determining module 303. The modules 201-203 and 301-303 can include one or more software programs in the form of computerized codes stored in the storage device 11. The computerized codes can include instructions executed by the processing device 30 to provide functions for the modules 201-203 and 303-303.

The creating module 301 can create the preset facial image of the user. In detail, the camera 14 first captures a plurality of photos from different angles of a face of the user to obtain a face template of the user. The creating module 301 can process the face template to obtain a clear image. The creating module 301 can classify a plurality of parts of the face template. The plurality of parts can include the eyes, nose, mouth, and the like of the user. The creating module 301 can determine corresponding eigenvectors of the plurality of parts, and add the eigenvectors to the face template.

The receiving module 201 can receive a name of each application input by the user, and receive a username and password corresponding to each application input by the user.

The linking module 202 can create the plurality of linking relationships by linking the preset facial image to each application name and the corresponding username and password.

The login module 203 can log into the plurality of applications. In detail, when opening a first application of the plurality of applications, the login module 203 sends a recognition request to the facial recognition unit 30. After receiving the recognition request, the obtaining module 302 controls the camera 14 to capture the login facial image.

The determining module 303 can determine whether the login facial image matches the preset facial image. When the login facial image matches the preset facial image, the login module 203 can automatically log into the first application by sending the corresponding username and password to a server of the first application.

After the login facial image matches the preset facial image to log into the first application, the login module 203 can automatically log into the rest of the applications when the rest of the applications are opened by sending the corresponding username and password to the corresponding servers of the applications. The login module 203 can obtain the corresponding usernames and passwords according to the linking relationships in the storage device 11. The login facial image of the user only needs to be matched to the preset facial image when opening the first application, and then the rest of the applications can be logged into automatically when opened. In another embodiment, the electronic device can automatically open a plurality of applications for a plurality of different users of the electronic device 1. For example, when one of the plurality of users opens a first application of the plurality of applications, the camera 14 captures a login facial image of the user, the determining module 303 determines whether the login facial image matches a corresponding preset facial image, and the login module 203 can automatically log into the first application and the rest of the plurality of applications of the user when the login facial image matches the preset facial image.

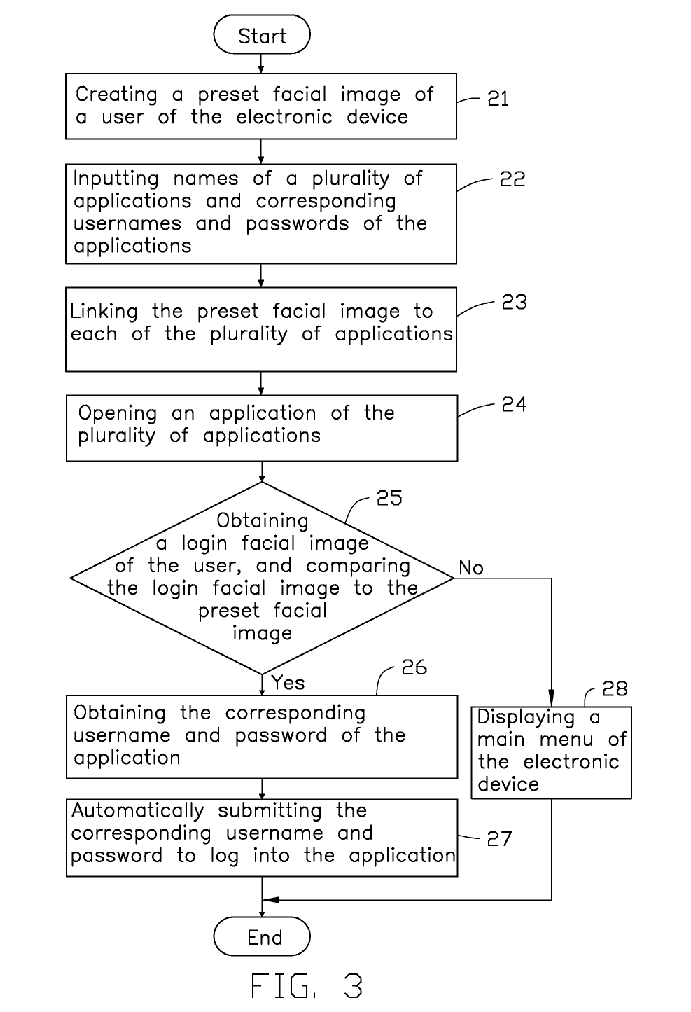

FIG. 3 illustrates a flowchart of an exemplary method for opening a plurality of applications of an electronic device. The example method is provided by way of example, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 21.

At block 21, a preset facial image of a user of the electronic device can be created. In detail, a camera of the electronic device first captures a plurality of photos from different angles of a face of the user to obtain a face template of the user. The electronic device can process the face template to obtain a clear image. The electronic device can classify a plurality of parts of the face template. The plurality of parts can include the eyes, nose, mouth, and the like of the user. The electronic device can determine corresponding eigenvectors of the plurality of parts, and add the eigenvectors to the face template.

At block 22, a name of each of the plurality of applications can be input to the electronic device, and corresponding usernames and passwords of the applications can be input.

At block 23, the preset facial image can be linked to each of the plurality of applications, thereby creating a plurality of linking relationships. The plurality of linking relationships can be stored in a storage device of the electronic device.

At block 24, an application of the plurality of applications can be opened.

At block 25, a login facial image of the user can be obtained from the camera. The login facial image can be compared to the preset facial image. When the login facial image matches the preset facial image, block 26 is implemented. When the login facial image does not match the preset facial image, block 28 is implemented.

At block 26, the corresponding username and password of the application can be obtained from the storage device of the electronic device.

At block 27, the electronic device can automatically submit the corresponding username and password to a server of the application to log into the application.

At block 28, a main menu of the electronic device can be displayed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for logging into a plurality of applications of an electronic device associated with at least one user, the method comprising:
obtaining a login facial image of the at least one user of the electronic device when a first application of the plurality of applications is opened;
determining whether the login facial image of the at least one user matches a preset facial image stored in the electronic device; and
logging into the first application when the login facial image matches the preset facial image;
wherein the preset facial image is linked to each of the plurality of applications; and
wherein the electronic device automatically logs into the plurality of applications when the plurality of applications are opened, after the login facial image matches the preset facial image to log into the first application.

2. The method as in claim 1, wherein:
each of the plurality of applications requires a preset username and password to be logged into;
the electronic device automatically submits the username and password of the first application to a server associated with the first application after the login facial image matches the preset facial image; and
the electronic device automatically submits the corresponding usernames and passwords to corresponding servers of the plurality of applications to log into the plurality of applications when the plurality of applications are opened.

3. The method as in claim 1, wherein the login facial image and the preset facial image are captured by a camera of the electronic device.

4. The method as in claim 3, wherein the preset facial image is created by:
capturing a plurality of photos from different angles of a face of the at least one user to obtain a face template of the at least one user;
processing the face template to obtain a clear image;
classifying a plurality of parts of the face template and corresponding eigenvectors of the plurality of parts; and
adding the eigenvectors of the plurality of parts to the face template.

5. The method as in claim 1, wherein the preset facial image is linked to each of the plurality of applications by the at least one user inputting a name of the application and the corresponding username and password.

6. The method as in claim 1, wherein:
the electronic device is associated with a plurality of users;
the step of obtaining a login facial image is related to obtaining a login facial image of one of the plurality of users of the electronic device when the first application of the plurality of applications is opened; and
the step of determining whether the login facial image of the at least one user matches a preset facial image is related to determining whether the login facial image of the one of the plurality of users matches a preset facial image.

7. An electronic device for logging into a plurality of applications, the electronic device comprising:
a display configured to display the plurality of applications on the electronic device;
a camera configured to capture a login facial image of a user;
a facial recognition and login integration system configured to determine whether the login facial image matches a preset facial image, and automatically log into the plurality of applications when the login facial image matches the preset facial image;
a storage device configured to store the preset facial image and a plurality of linking relationships between the preset facial image and each of the plurality of applications; and
a processing module configured to execute a plurality of instructions of a plurality of modules of the facial recognition and login integration system;
wherein the plurality of instructions of the plurality of modules of the facial recognition and login integration system is stored in the storage device; and
wherein the facial recognition and login integration system automatically logs into the plurality of applications according to the linking relationships.

8. The electronic device as in claim 7, wherein each linking relationship is created by inputting a name of the corresponding application, and inputting a corresponding username and password for logging into the corresponding application.

9. The electronic device as in claim 7, wherein the facial recognition and login integration system comprises:
a login integration unit configured to link the preset facial image to the plurality of applications and log into the plurality of applications; and
a facial recognition unit configured to create the preset facial image and determine whether the login facial image matches the preset facial image.

10. The electronic device as in claim 9, wherein the login integration unit comprises:
a receiving module configured to receive the names of the plurality of applications and the corresponding usernames and passwords input by the user;
a linking module configured to link the preset facial image of the user to each of the plurality of applications, and save the preset facial image and the linking relationships to the storage device; and
a login module configured to automatically log into the plurality of applications when the login facial image matches the preset facial image.

11. The electronic device as in claim 10, wherein:
the login module sends a recognition request to the facial recognition unit when a first application of the plurality of applications is opened;
the facial recognition unit obtains the login facial image after receiving the login request;
the login module automatically logs into the first application when the login facial image matches the preset facial image; and
the login module automatically logs into the plurality of applications when the plurality of applications are opened after the login facial image matches the preset facial image to log into the first application.

12. The electronic device as in claim 11, wherein the login module logs into each application by sending the corresponding username and password to a server corresponding to the application.

13. The electronic device as in claim 9, wherein the facial recognition unit comprises:
a creating module configured to create the preset facial image;
an obtaining module configured to control the camera to capture the login facial image; and
a determining module configured to determine whether the login facial image matches the preset facial image.

14. The electronic device as in claim 13, wherein the creating module creates the preset facial image by:
capturing a plurality of photos from different angles of a face of the user to obtain a face template of the user;
processing the face template to obtain a clear image;
classifying a plurality of parts of the face template and obtaining corresponding eigenvectors of the plurality of parts; and
adding the eigenvectors of the plurality of parts to the face template.
